(19) United States
(12) Patent Application Publication
(10) Pub. No.: US 2010/0227897 A1
(43) Pub. Date: Sep. 9, 2010

(54) Composition for Controlling Colorado Potato Beetles

(75) Inventors: Helen Pruul, Brussels (BE); Michel Sarazin, Ecully (FR); Marc Hullebroeck, Sint-Nicklaas (BE)

Correspondence Address: PATENT ADMINISTRATOR;FMC CORPORATION, 1735 MARKET STREET, PHILADELPHIA, PA, 19103, US

(73) Assignee: FMC CORPORATION, Philadelphia, PA (US)

(21) Appl. No.: 12/279,618

(22) PCT Filed: Feb. 20, 2007
(86) PCT No.: PCT/US2007/062421

§ 371 Date: Aug. 15, 2008

Related U.S. Application Data
(60) Provisional application No. 60/776,158, filed on Feb. 23, 2006.

(51) Int. Cl. A01N 43/40; A01N 43/56; A01P 7/04

(52) U.S. Cl. 514/357; 514/407

(57) ABSTRACT

The present invention relates to an insecticidal composition suitable for use in controlling Colorado potato beetles comprising zeta-cypermethrin and a second insecticide selected from the group consisting of acetamiprid and fipronil.

This application claims the benefit of U.S. Provisional Application No. 60/776,158, filed Feb. 23, 2006.

### FIELD OF THE INVENTION

The present invention relates to the field of controlling Colorado potato beetles.

### BACKGROUND OF THE INVENTION

Colorado potato beetles (Leptinotarsa decemlineata Say) are an insect pest causing major damage in commercial potato crops by feeding on the potato leaves causing considerable crop loss. Colorado potato beetles over winter in the soil as adults, emerging in the spring. These adults feed on newly sprouted host plants where they mate. Females deposit eggs on the host plant's leaves as egg masses of from 10 to 40 eggs. Most females are able to lay 300 to 500 eggs during a period of four to five weeks. Eggs hatch in four to five days and the larvae begin to feed on the potato foliage. The larvae feed almost consistently, stopping only when molting. The four larval instars last a total of 21 days. Fully grown larvae burrow in the ground to pupate and in five to ten days emerge as adults. There are two and occasionally a partial third generation of Colorado potato beetles each year. Insecticides that arc approved for use on potatoes arc used to control this pest, however these approved pesticides have to be reapplied two to three times in order to adequately control Colorado potato beetle infestations.

It would be advantageous to provide a new composition for controlling Colorado potato beetles that would provide better control for a longer period of time, possibly eliminating additional insecticide treatments during the growing season.

### SUMMARY OF THE INVENTION

In accordance with the present invention, it has now been found that a new insecticidal composition improves control of Colorado potato beetles (Leptinotarsa decemlineata Say) for a longer period of time. Specifically, the present invention is directed to an insecticidal composition, suitable for use in controlling Colorado potato beetles comprising zeta-cypermethrin and a second insecticide selected from the group consisting of acetamiprid and fipronil. Other aspects of the present invention will also be apparent.

### DETAILED DESCRIPTION OF THE INVENTION

The present invention relates to an insecticidal composition suitable for use in controlling Colorado potato beetles comprising zeta-cypermethrin and a second insecticide selected from the group consisting of acetamiprid and fipronil. The compositions of the present invention exhibit better insecticidal control for periods of time longer than either of the individual insecticides.

In a preferred embodiment of the present invention, the ratio of zeta-cypermethrin active ingredient (AI) to the second insecticide AI may be from 1/99 to 99/1. Preferably the ratio of zeta-cypermethrin AI to the second insecticide AI is from 1/4 to 4/1. More preferably the ratio is from 1/2 to 2/1.

Another embodiment of the present invention relates to a method for controlling Colorado potato beetles comprising applying an insecticidally effective amount of a composition comprising zeta-cypermethrin and a second insecticide selected from the group consisting of acetamiprid and fipronil to a locus where Colorado potato beetle control is needed or expected to be needed.

The locus can be a Colorado potato beetle-infested area, a location that is expected to be Colorado potato beetle-infested, a location adjacent to a Colorado potato beetle-infested area or a location adjacent to an area that is expected to be Colorado potato beetle-infested.

As used in this specification and unless otherwise indicated the term “pesticide” refers to a molecule or combination of molecules that repels, inhibits or kills insects and can be used for crop protection. The term “insecticide” refers to a molecule or combination of molecules that repels, inhibits or kills insects, and can be used for crop protection. The term “pesticidally effective amount” means an amount necessary to produce an observable pesticidal effect on unwanted pests, including the effects of death, growth inhibition, reproduction inhibition, inhibition of proliferation, and removal, destruction, or otherwise diminishing the occurrence and activity of unwanted pests.

The insecticides of the present invention may be derived from commercially available formulations of insecticides. For example, without limitation, zeta-cypermethrin sold by FMC Corporation under the name and trademark of Fury 10 EW (100 gm-AI/L emulsion, oil in water), acetamiprid sold by Nisso under the name Mospilan 20 SP (20% by weight AI, soluble powder)and fipronil sold by BASF under the name Regent 200 SC (200 gm-AI/L suspension concentrate) find utility in the present invention. Using methods known to one skilled in the art, the above-mentioned formulations of insecticides can be dispersed in an aqueous medium to provide a composition useful in this invention.

The term “locus” refers to any locations where control of Colorado potato beetles is needed or is expected to be needed. The terms “control”, “controlling” or “percent control” may be used interchangeably, and refer to the killing of Colorado potato beetles. The term “zeta-cypermethrin” refers to (R,S)-α-cyano-3-phenoxybenzyl-(1R,S)-cis-trans-3-(2,2-dichlorovinyl)-2,2-dimethylcyclopropanecarboxylate which has been enriched in the 1R-cis-S and 1R-trans-S isomers. The term “acetamiprid” refers to (E)-N¹-[(6-chloro-3-pyridyl)methyl]-N²-cyano-N¹-methylacetamidine(E)-N¹-[(6-chloro-3-pyridyl)methyl]-N²-cyano-N¹-methylacetamidine. The term “fipronil” refers to 5-amino-1-(2,6-dichloro-α,α,α-trifluoro-p-tolyl)-4-trifluoromethylsulfinylpyrazole-3-carbonitrile.

The following example further illustrates the present invention, but, of course, should not be construed as in any way limiting its scope. The example sets forth certain data demonstrating the improved efficacy of the compositions of the present invention.

### EXAMPLE

### Control of Colorado Potato Beetles

The compositions of the present invention were tested for Colorado Potato Beetle activity in the following manner:

Test compositions made up of Fury 10 EW, Mospilan 20 SP and Regent 200 SC were prepared that provided appropriate rates of application of combinations of zeta-cypermethrin, acetamiprid and fipronil, as well as zeta-cypermethrin, acetamiprid and fipronil alone.

The test was set up as a randomized complete block with 3 replicates. Each test plot was 24 meters square containing 3 rows of 50 plants. All test materials were applied as a foliar spray in 300 liters per hectare of water using a PILMET 212 sprayer at 0.35 Mpa. Observations were made before treatment (0 days), 3 days after treatment (DAT), 7 DAT, 14 DAT, 21 DAT and 28 DAT. For each observation 50 plants were inspected. For each observation the number of larvae reported was the total on the 10 most infested plants. Results reported are an average of three replicates. These results are reported in Table 1 below.

TABLE 1
Efficacy on Colorado Potato Beetles

| | | Number | Number | Number | Number | Number | Number |
|---|---|---|---|---|---|---|---|
| | Rate of | Larvae | Larvae | Larvae | Larvae | Larvae | Larvae |
| | Appln. | Alive | Alive | Alive | Alive | Alive | Alive |
| | (per | 0 | 3 | 7 | 14 | 21 | 28 |
| Treatment | hectare) | Days | DAT | DAT | DAT | DAT | DAT |
| A | 200 ml | 303 | 10 | 18 | 15 | 43 | 20 |
| B | 100 g | 362 | 8 | 22 | 18 | 38 | 47 |
| C | 100 ml | 359 | 2 | 0 | 0 | 22 | 17 |
| A + B | 200 ml + | 342 | 0 | 13 | 5 | 13 | 27 |
| | 100 g | | | | | | |
| | 150 ml + | 268 | 0 | 2 | 7 | 23 | 33 |
| | 75 g | | | | | | |
| | 100 ml + | 383 | 0 | 7 | 8 | 17 | 18 |
| | 50 g | | | | | | |
| | 200 ml + | 275 | 2 | 2 | 3 | 12 | 27 |
| | 50 g | | | | | | |
| | 100 ml + | 92 | 0 | 0 | 3 | 5 | 5 |
| | 100 g | | | | | | |
| A + C | 150 ml + | 160 | 0 | 0 | 0 | 0 | 2 |
| | 75 ml | | | | | | |
| Untreated | 0 | 340 | 261 | 186 | 248 | 74 | 21 |

A is zeta-cypermethrin (Fury 10 EW)
B is acetamiprid (Mospilan 20 SP)
C is fipronil (Regent 200 SC)

Those of ordinary skill in the art will appreciate that variations of the invention may be used and that it is intended that the invention may be practiced otherwise than as specifically described herein. Accordingly, this invention includes all modifications encompassed within the spirit and scope of the invention as defined by the following claims.

What is claimed is:

1. An insecticidal composition suitable for use in controlling Colorado potato beetles comprising
i) zeta-cypermethrin and
ii) a second insecticide selected from the group consisting of acetamiprid and fipronil.

2. The composition of claim 1, wherein the ratio of zeta-cypermethrin active ingredient to the second insecticide active ingredient is from 1/99 to 99/1.

3. The composition of claim 1, wherein the ratio of zeta-cypermethrin active ingredient to the second insecticide active ingredient is from 1/4 to 4/1.

4. The composition of claim 1, wherein the ratio of zeta-cypermethrin active ingredient to the second insecticide active ingredient is from 1/2 to 2/1.

5. A method for controlling Colorado potato beetles comprising applying an insecticidally effective amount of the composition of claim 1 to a locus where Colorado potato beetle control is needed or expected to be needed.

6. The method according to claim 5, wherein said locus is a Colorado potato beetle-infested area, a location that is expected to be Colorado potato beetle-infested, a location adjacent to a Colorado potato beetle-infested area or a location adjacent to an area that is expected to be Colorado potato beetle-infested.
